(19) United States
(12) Patent Application Publication
(10) Pub. No.: US 2010/0086468 A1
(43) Pub. Date: Apr. 8, 2010

(54) METHOD FOR PRODUCING HYDROCYANIC ACID (HCN)

(75) Inventors: Thomas Schaefer, Buettelborn (DE); Hermann Siegert, Seeheim-Jugenheim (DE); Thomas Krauss, Bickenbach (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Roehm GmbH, Darmstadt (DE)

(21) Appl. No.: 12/530,836

(22) PCT Filed: Jan. 22, 2008
(86) PCT No.: PCT/EP08/50665

§ 371 Date: Sep. 11, 2009

(30) Foreign Application Priority Data
Mar. 23, 2007 (DE) 10 2007 014 586.3

(51) Int. Cl. C01C 3/04

(52) U.S. Cl. 423/376

(57) ABSTRACT

The present invention relates to a process for preparing hydrogen cyanide by the Andrussow process by reacting methane-containing gas, ammonia and oxygen-containing gas over a catalyst at elevated temperature, wherein the proportion by volume of oxygen in relation to the total volume of nitrogen and oxygen (O₂/(O₂+N₂)) is in the range of 0.2 to 1.0 and the reaction is performed with a non-ignitable reactant gas mixture.

The present invention relates to an improvement in the Andrussow process for preparing hydrogen cyanide (HCN).

The synthesis of hydrogen cyanide (hydrocyanic acid) by the Andrussow process is described in Ullmann's Encyclopedia of Industrial Chemistry, Volume 8, VCH Verlagsgesellschaft, Weinheim 1987, pages 161-162. The reactant gas mixture, which generally comprises methane or a methane-containing natural gas stream, ammonia and oxygen, is passed through catalyst meshes in a reactor and reacted at temperatures of approx. 1000° C. The oxygen needed is typically used in the form of air. The catalyst meshes consist of platinum or platinum alloys. The composition of the reactant gas mixture corresponds roughly to the stoichiometry of the net reaction equation which proceeds exothermically.

CH₄+NH₃+3/2O₂→HCN+3H₂O dHr=−473.9kJ.

The reaction gas flowing away comprises the HCN product, unconverted NH₃ and CH₄, and the significant by-products CO, H₂, H₂O, CO₂ and a large proportion of N₂.

The reaction gas is cooled rapidly to approx. 150-200° C. in a waste-heat boiler and then passes through a wash column in which the unconverted NH₃ is washed out with dilute sulphuric acid and parts of the steam are condensed. Also known is the absorption of NH₃ with sodium hydrogenphosphate solution and subsequent recycling of the ammonia. In a downstream absorption column, HCN is absorbed in cold water and is formed with a purity of greater than 99.5% by mass in a downstream rectification. The HCN-containing water obtained in the bottom of the column is cooled and recycled to the HCN absorption column.

A wide spectrum of possible versions of the Andrussow process is described in DE 549 055.

As specified by way of example, a catalyst is employed which consists of a plurality of fine meshes arranged in series, composed of Pt with 10% rhodium, at temperatures of approx. 980-1050° C. The HCN yield, based on NH₃ used, is 66.1%.

One method for maximizing the HCN yield by optimal adjustment of the air/natural gas and of the air/ammonia ratio is described in U.S. Pat. No. 4,128,622.

In addition to the usual procedure with air as the oxygen provider, various documents describe the enrichment of the air with oxygen. Tab. 1 lists some patents with the operating conditions specified therein.

TABLE 1

| | corresponds to: | |
|---|---|---|
| | DE 12 83 209, 1968 | |
| | Società Edison | DE-A 12 88 575, 1968 |
| | Pat 660 4519 NL | Società Edison |
| | Pat 679 440 BE | Pat 660 4697 NL |
| | U.S. Pat. No. 3,379,500 | Pat 679 529 BE |
| Reactant gas | | 200-400° C. |
| preheating | | 300-380° C. |
| Mesh temperature | 1100-1200° C. | 1100-1200° C. |
| molar (O₂ + N₂)/CH₄ | 6.5-1.55 | 6.0-1.6 |
| ratio | 4.55-2.80 | 4.5-2.6 |
| (O₂ + N₂)/NH₃ | 6.8-2.0 | 6.0-2.0 |
| | 4.8-3.65 | 4.5-3.0 |
| CH₄/NH₃ | 1.4-1.05 | 1.3-1.0 |
| | 1.3-1.1 | 1.25-1.05 |
| O₂/(O₂ + N₂) | 0.245-0.4 | 0.245-0.35 |
| | 0.27-0.317 | 0.25-0.30 |

| | PCT 97/09273, 1997 |
|---|---|
| | ICI |
| | (special reactor) |
| Reactant gas | 200-400° C. |
| preheating | further temperature data for |
| | individual reactant gas |
| | streams |
| Mesh temperature | 1000-1250° C. |
| molar (O₂ + N₂)/CH₄ | |
| ratio | |
| (O₂ + N₂)/NH₃ | |
| CH₄/NH₃ | 1.0-1.5 |
| O₂/(O₂ + N₂) | 0.3-1.0 |

WO 97/09273 solves the disadvantages of a large N₂ dilution of the reaction gases by using preheated, detonatable mixtures of methane, ammonia and oxygen-enriched air or pure oxygen.

In order to be able to handle the detonatable mixtures safely, a special reactor which prevents the detonation of the reaction mixture is used. The use of this solution in industrial practice entails a capital-intensive modification of existing HCN plants.

Both in an operating mode with air and in the case of oxygen enrichment, which is performed in accordance with the prior art, disadvantages arise and will be explained below.

When oxygen is used as the oxygen provider in the reactant gas mixture, the HCN concentration in the reaction gas is only approx. 6-8% by volume. Owing to the establishment of equilibrium, the low HCN concentration in the reaction gas causes a relatively low HCN concentration in the aqueous bottom exit stream of the HCN absorber column of 2-3% by mass. A high energy expenditure is thus required to cool and remove the large flow rate of absorption water. In addition, the high inert gas fraction causes relatively large apparatus volumes and streams in the workup part of the process. Owing to the dilution with nitrogen, the water content in the residual gas stream is less than 18% by volume. The hydrogen thus cannot be isolated as a material of value in an economically viable manner.

Although the known processes with oxygen enrichment of the reactant gas (see table 1) improve the disadvantages mentioned for the air method, they additionally lead to other restrictions. Examples are:
1. When the reactant gas ratios (vol/vol) of O₂/NH₃ or O₂/CH₄ are not adjusted to the degree of oxygen enrichment, there is insufficient separation of the NH₃/CH₄/N₂/O₂ mixture from the upper explosion limit and safe operation of the reactor is no longer ensured. Possible effects are:
   risk of explosion
   risk of deflagration (damage to the catalyst mesh)
   risk of locally occurring temperature peaks which damage the catalyst mesh.
2. The increased oxygen supply at the catalyst leads to enhanced oxidation of NH₃ to N₂ and hence to a reduction in the HCN yield based on the NH₃ used.
3. The degree of oxygen enrichment is limited in the known processes to an enrichment up to 40% O₂ in the oxygen-nitrogen mixture (DE 1 283 209, DE 1 288 575).
4. Oxygen enrichment in the reactant gas can establish an increased catalyst mesh temperature which leads to more rapid damage and deactivation of the catalyst.
5. Approaches to solutions by countering the existing disadvantages with a specially constructed reactor (WO 97/09273) entail high capital costs and are not capable of increasing the performance of existing plants inexpensively.

In view of the prior art, it is thus an object of the present invention to provide processes for preparing HCN which can be performed in a particularly simple and inexpensive manner and with high yield. In this context, the production output (kg of HCN/h) in particular should be increased in existing plants. In addition, it was consequently an object of the present invention to provide a process which enables production of HCN with a particularly low energy to demand. Furthermore, safe plant operation should be enabled by the process without expensive modifications being necessary. Moreover, it was an object of the present invention to provide a process with a high HCN yield. In the process according to the invention, the catalyst meshes should have a particularly long lifetime.

These objects and further objects which are not stated explicitly but which can be derived or discerned immediately from the connections discussed herein by way of introduction, are achieved by a process having all features of claim 1. Appropriate modifications to the process according to the invention are protected in subclaims.

By virtue of the proportion by volume of oxygen in relation to the total volume of nitrogen and oxygen (O₂/(O₂+N₂)) being in the range of 0.2 to 1.0 and the reaction being performed with a non-ignitable reactant gas mixture, it is surprisingly possible to provide a process for preparing hydrogen cyanide by the Andrussow process by reacting methane-containing gas, ammonia and oxygen-containing gas over a catalyst at elevated temperature, which can be performed in a simple and inexpensive manner and with high yield.

The process according to the invention can additionally achieve the following advantages.

The production output of existing HCN reactors can be increased by up to 300% compared to the operating mode with air when the air is replaced completely by oxygen (molar O₂/(O₂+N₂) ratio=1.0).

The process according to the invention succeeds surprisingly not only in increasing the production output but simultaneously in improving the hydrogen cyanide yield based on the expensive NH₃ raw material.

At the same time, a residual gas with low nitrogen content and hence high calorific value is obtained.

Equally, a significant reduction in the energy demand per t of HCN produced is achieved by virtue of less water having to be conducted in circulation to absorb the HCN formed owing to the greater HCN concentration in the reaction gas.

Moreover, a production output of the catalyst comparable with the operating mode with air (amount of HCN production per kg of catalyst over the total run time of the catalyst) is achieved.

The improvements mentioned are achieved with a non-ignitable reactant gas mixture and ensure a safe operating mode of the reactor.

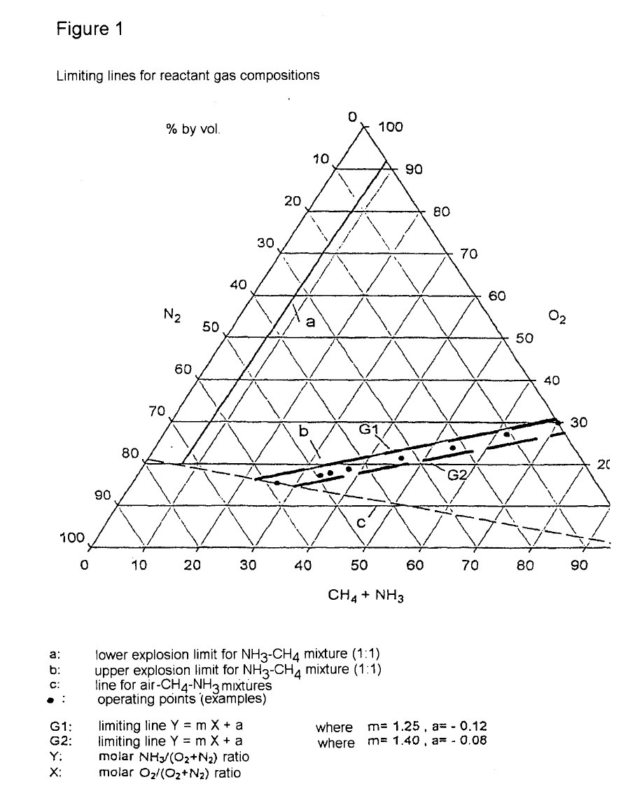

It is a further advantage of the process according to the invention that the process can be performed in existing plants for hydrocyanic acid preparation. No costly modifications are required (Ullmann's Encyclopedia of Industrial Chemistry 5th Edition, Vol. A8, p. 159 ff. (1987)). Since the mixture is outside the detonation limits, complicated reactors, as described, for example, in WO 97/09273, FIG. 1, are not required. Moreover, there is no need to keep a wide safety margin from the self-ignition temperature of the mixture (min. 50° C.), as described in WO 97/09273 (p. 1 line 35-p. 2 line 2). Thus, even in existing plants for hydrocyanic acid preparation, an improved space-time yield is achieved.

The degree of oxygen enrichment may be up to 100% O₂ in the oxygen-nitrogen mixture.

In addition, the catalyst meshes exhibit a particularly long lifetime.

According to the invention, hydrogen cyanide is prepared by the Andrussow process. These processes are known per se and are described in detail in the prior art cited above. Since the reaction takes place outside the detonation limits of the reactant gas mixture, which generally comprises oxygen, methane and ammonia, the reaction can be performed in a conventional Andrussow reactor. These reactors are likewise known from the above publications.

For the preparation of HCN, according to the invention, a methane-containing gas is used. Typically, any gas with a sufficiently high proportion of methane can be used. The proportion of methane is preferably at least 85% by volume, more preferably at least 88% by volume. In addition to methane, it is also possible to use natural gas in the reactant gas. Natural gas is understood here to mean a gas which contains at least 88% by volume of methane.

In one aspect of the present invention, the oxygen-containing gas used may be oxygen or a nitrogen-oxygen mixture. In this case, the proportion by volume of oxygen in relation to the total volume of oxygen and nitrogen (O₂/(O₂+N₂)) is in the range of 0.2 to 1.0 (vol./vol.). In a particular aspect of the present invention, air is used as the oxygen-containing gas.

In a preferred aspect of the present invention, the proportion by volume of oxygen in relation to the total volume of nitrogen and oxygen (O₂/(O₂+N₂)) is in the range of 0.25 to 1.0 (vol./vol.). In a particular aspect, this proportion may preferably be in the range of greater than 0.4 to 1.0. In a further aspect of the present invention, the proportion by volume of oxygen in relation to the total volume of nitrogen and oxygen (O₂/(O₂+N₂)) may be in the range of 0.25 to 0.4.

The molar ratio of methane to ammonia (CH₄/NH₃) in the reactant gas mixture may be in the range of 0.95 to 1.05 mol/mol, more preferably in the range of 0.98 to 1.02.

The reaction temperature is preferably between 950° C. and 1200° C., preferably between 1000° C. and 1150° C. The reaction temperature may be adjusted via the proportion of the different gases in the reactant gas stream, for example via the O₂/NH₃ ratio. In this case, the composition of the reactant gas mixture is adjusted such that the reactant gas is outside the concentration range of ignitable mixtures. Examples of possible operation points are shown in FIG. 1. The temperature of the catalyst mesh is measured by means of a thermoelement or by means of a radiation pyrometer. Viewed in flow direction of the gases, the measurement point may be beyond the catalyst mesh at a distance of approx. 0-10 cm.

The molar ratio of oxygen to ammonia (O₂/NH₃) is preferably in the range of 0.7 to 1.25 (mol/mol).

The molar NH₃/(O₂+N₂) ratio may preferably be adjusted as a function of the molar O₂/(O₂+N₂) ratio. The following relationship preferably applies to the molar NH₃/(O₂+N₂) and O₂/(O₂+N₂) ratios:

Y≦1.4X−0.05, more preferably Y≦1.4X−0.08, in which
Y is the molar NH₃/(O₂+N₂) ratio and
X is the molar O₂/(O₂+N₂) ratio.

In addition, the following relationship may preferably apply to the molar NH₃/(O₂+N₂) and O₂/(O₂+N₂) ratios:

Y≧1.25X−0.12, more preferably Y≧1.25X−0.10, in which
Y is the molar NH₃/(O₂+N₂) ratio and
X is the molar O₂/(O₂+N₂) ratio.

The composition of the reactant gas mixture may more preferably be within a concentration band which is limited by the two straight lines Y=1.4X−0.08 and Y=1.25X−0.12, in which Y is the molar NH₃/(O₂+N₂) ratio and X is the molar O₂/(O₂+N₂) ratio (see FIG. 1).

Depending on the molar ratio X, an advantageous molar ratio Y follows from inserting the parameters m and a into the straight-line equation Y=mX−a, where the parameters are within the following ranges:

m is preferably in the range of 1.25 to 1.40, more preferably in the range of 1.25 to 1.33 and
a is preferably in the range of 0.05 to 0.14, more preferably in the range of 0.07 to 0.11 and most preferably in the range of 0.08 to 0.12.

The reactant gas mixture may preferably be preheated to a maximum of 150° C., more preferably a maximum of 120° C.

FIG. 1 describes reactant gas compositions shown in an explosion diagram.

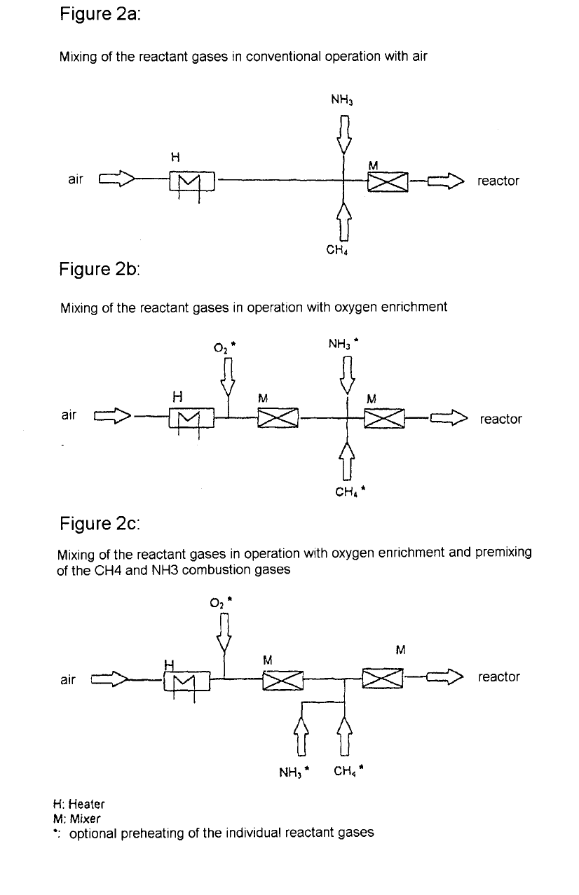

FIG. 2a describes the mixing of the gases in the method with air as the oxygen carrier. FIG. 2b and 2c describe preferred variants in which oxygen is metered into the airstream. This allows an oxygen-enriched airstream to be prepared.

The present invention will be illustrated below with reference to examples, without any intention that this should impose a restriction.

### EXAMPLES

Examples described below were performed in a laboratory apparatus consisting of a gas metering system with thermal mass flow regulators for the reactant gases used (methane, ammonia, air, oxygen), an electrical heater for preheating the reactant gases, a reactor part (internal diameter d: 25 mm) with 6 layers of a Pt/Rh 10 catalyst mesh and a downstream HCN scrubber for neutralizing the HCN formed with NaOH solution.

The reaction gas was analyzed online in a GC. To assess the amount of HCN formed, the CN content was additionally determined by argentometric titration in the effluent of the HCN scrubber. Proceeding from an operating mode corresponding to the known operating conditions with air as the oxygen source, atmospheric oxygen was increasingly replaced by pure oxygen in an experimental series and, at the same time, the molar O₂/NH₃ ratio was reduced with constant CH₄/NH₃ ratio. All experiments were performed with a constant reactant gas volume flow rate of 24 1 (STP)/min. Table 2 shows a selection of representative results.

TABLE 2
Experimental results for O₂ enrichment in the reactant gas

| | | | | Mesh |
|---|---|---|---|---|
| | O₂ content¹⁾ | molar ratio | | temperature T_{N} |
| No. | V_{O2}/(V_{O2} + V_{N2}) | O₂/NH₃ | CH₄/NH₃ | ° C. |
| 1 | 0.21²⁾ | 1.15 | 0.98 | 994 |
| 2 | 0.259 | 1.02 | 0.98 | 1011 |
| 3 | 0.300 | 0.98 | 0.98 | 1022 |
| 4 | 0.393 | 0.92 | 0.98 | 1032 |
| 5 | 0.516 | 0.88 | 0.98 | 1034 |
| 6 | 0.714 | 0.87 | 0.98 | 1010 |
| 7 | 1.00³⁾ | 0.84 | 0.99 | Fault |

| | |
|---|---|
| HCN conc. in the | specific yield |

| | reaction gas | Reactor output L_{spec} | HCN |
|---|---|---|---|
| No. | % by vol. | kg HCN/h/m² | % |
| 1 | 7.6 | 303 | 62.9 |
| 2 | 9.1 | 380 | 62.4 |
| 3 | 10.1 | 442 | 64.5 |
| 4 | 12.0 | 542 | 65.6 |
| 5 | 13.7 | 650 | 66.3 |
| 6 | 14.6 | 750 | 66.8 |
| 7 | 16.7 | 863 | 68.0 |

(dᵢ: 25 mm, volume flow rate V′_{F}: 24 1 (STP)/min, reactant gas temp. T_{F}: 60° C.)
¹⁾O₂ content in the oxygen-air mixture;
²⁾only atmospheric oxygen;
³⁾method with pure oxygen without air
L_{spec}: Amount of HCN produced in kg/(h*m²) based on the cross-sectional area of the catalyst mesh

At constant gas volume flow rate, the specific reactor output (amount of HCN production in kg/(h*m²) based on the cross-sectional area of the catalyst mesh) rises from approx. 300 kg of HCN/h/m² (oxidizing agent only atmospheric oxygen) to approx. 860 kg of HCN/h/m² in a method with pure oxygen as the oxidizing agent. The HCN yield based on ammonia used A_{HCN,NH3} improves from 63% to 68%. The HCN concentration in the reaction gas rises with decreasing proportion of nitrogen in the reactant gas from 7.6% by volume to 16.7% by volume.

1. A process for preparing hydrogen cyanide by the Andrussow process by reacting a methane-containing gas, ammonia and an oxygen-containing gas over a catalyst at an elevated temperature, wherein the proportion by volume of oxygen in relation to the total volume of nitrogen and oxygen (O₂/(O₂+N₂)) is in the range of 0.2 to 1.0 and the reaction is performed with a non-ignitable reactant gas mixture.

2. The process according to claim 1, wherein the molar ratio of methane to ammonia (CH₄/NH₃) in the reactant gas mixture is in the range of 0.95 to 1.05.

3. The process according to claim 1, wherein the following relationship applies to the molar NH₃/(O₂+N₂) and O₂/(O₂+N₂) ratios:
Y≦1.4X−0.05, in which
Y is the molar NH₃/(O₂+N₂) ratio and
X is the molar O₂/(O₂+N₂) ratio.

4. The process according to claim 1, wherein the following relationship applies to the molar NH₃/(O₂+N₂) and O₂/(O₂+N₂) ratios:
Y≧1.25X−0.12, in which
Y is the molar NH₃/(O₂+N₂) ratio and
X is the molar O₂/(O₂+N₂) ratio.

5. The process according to claim 1, wherein air is used as the oxygen-containing gas.

6. The process according to claim 1, wherein the proportion by volume of oxygen in relation to the total volume of nitrogen and oxygen (O₂/(O₂+N₂)) is in the range of 0.25 to 1.0.

7. The process according to claim 6, wherein the proportion by volume of oxygen in relation to the total volume of nitrogen and oxygen (O₂/(O₂+N₂)) is in the range of greater than 0.4 to 1.0.

8. The process according to claim 6, wherein the proportion by volume of oxygen in relation to the total volume of nitrogen and oxygen (O₂/(O₂+N₂)) is in the range of 0.25 to 0.4.

9. The process according to claim 1, wherein an oxygen stream is mixed with an airstream before the combustion gases are added.

10. The process according to claim 1, wherein the stream of the methane-containing gas and the ammonia stream are mixed before the metered addition to the stream of the oxygen-containing gas.

11. The process according to claim 1, wherein the reactant gas mixture is preheated to a maximum of 150° C.

12. The process according to claim 11, wherein the reactant gas mixture is preheated to a maximum of 120° C.
